(19) United States
(12) Patent Application Publication
(10) Pub. No.: US 2023/0026379 A1
(43) Pub. Date: Jan. 26, 2023

(54) REUSABLE CANDLE SYSTEM AND METHOD THEREFOR

(71) Applicant: COSONDRA SJOSTROM, SAN JUAN, PR (US)

(72) Inventor: COSONDRA SJOSTROM, SAN JUAN, PR (US)

(21) Appl. No.: 17/745,579

(22) Filed: May 16, 2022

Related U.S. Application Data
(60) Provisional application No. 63/225,810, filed on Jul. 26, 2021.

(51) Int. Cl. C11C 5/02; C11C 5/00

(52) U.S. Cl. CPC C11C 5/023; C11C 5/006

(57) ABSTRACT

A reusable candle system allows a user to not create waste from single-use container candles while being safer. The molds have identical interiors to the candle inserts, therefore being able to create candles that fit perfectly into the inserts. The candle formed may be positioned in an insert having a wick stabilizer. The insert may then be placed in an exterior holder to protect the surface on which the candle is positioned upon and to protect a user from contact burns. Once the candle is depleted, the insert may be taken out of the exterior holder and cleaned and reused.

### RELATED APPLICATIONS

This patent application is related to U.S. Provisional Application No. 63/225,810 filed Jul. 26, 2021, entitled REUSABLE CANDLE SYSTEM AND METHOD″″ THEREFOR″ in the name of the same inventor, and which is incorporated herein by reference in its entirety. The present patent application claims the benefit under 35 U.S.C § 119(e).

### TECHNICAL FIELD

The present application generally relates to chandlery, and, more particularly, to a reusable candle system having a mold, an insert with a wick stabilizer, and an exterior holder housing the insert.

### BACKGROUND

Candles may typically be used for lighting and for decorative purposes. One of many types of candles commonly sold are candles in containers. Candles in containers face several challenges. Once these candles burn down, many individuals toss these single use containers away where they generally end up in landfills. Most all of these containers are formed of glass. The glass containers have a tendency to crack during transport, when roughly handled, or when overly heated by the candle. Further, the glass containers will likely not decompose in the landfill for hundreds of thousands of years.

Some individuals may try to recycle these glass candle containers. Unfortunately, if the wax from the glass containers is not removed and the glass containers are not totally clean, the recycling plant will most likely discard and throw these glass containers in the garbage. Further, these glass containers tend to get extremely hot when the candle is lit. The heat generated may not only damage the surface upon which the candle is placed but may also burn a user when the user tries to pick up and move the candle.

Therefore, it would be desirable to provide a system and method that overcomes the above problems.

### SUMMARY

In accordance with one embodiment, a reusable candle system is disclosed. The reusable candle system has an insert housing a candle and having a wick stabilizing device formed at a bottom of the insert for securing a wick of the candle in an upright manner. An exterior holder is used for housing the insert.

In accordance with one embodiment, a reusable candle system is disclosed. The reusable candle system has an insert housing a candle and having a wick stabilizing device formed at a bottom of the insert for securing a wick of the candle in an upright manner. A plurality of undulations formed on the bottom of the insert. An exterior holder housing the insert. A top covering an open top of the exterior holder.

In accordance with one embodiment, a reusable candle system is disclosed. The reusable candle system has an insert housing a candle. A plurality of wick stabilizing devices is formed at a bottom of the insert for securing a plurality of wicks of the candle in an upright manner, wherein the plurality of wick stabilizing devices is a plurality of circular indentations formed on the bottom of the insert. A plurality of undulations is formed on the bottom of the insert. An exterior holder is provided for housing the insert. A top is provided for covering an open top of the exterior holder. A mold is provided and sized to form a replacement candle to fit within the insert and to form a shipping container around the candle, wherein the mold is biodegradable.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIGS. 1A-1E depicts a method of using an exemplary embodiment of a reusable candle system according to one aspect of the present application;

FIG. 2 is a front view of an exemplary embodiment of a reusable candle system according to one aspect of the present application;

FIG. 3 is a cross-sectional view of an exemplary embodiment of an insert used in the reusable candle system according to one aspect of the present application;

FIG. 4 is a cross-sectional view of an exemplary embodiment of an insert used in the reusable candle system according to one aspect of the present application;

FIG. 5 is a cross-sectional view of an exemplary embodiment of an insert used in the reusable candle system according to one aspect of the present application;

FIG. 6 is a cross-sectional view of an exemplary embodiment of an insert used in the reusable candle system according to one aspect of the present application;

FIGS. 7A-7E are perspective views of exemplary embodiments of a reusable candle system according to one aspect of the present application;

FIGS. 8A-8E are perspective views of exemplary embodiments of a reusable candle system according to one aspect of the present application;

FIGS. 9A-9C are perspective views of exemplary embodiments of a reusable candle system according to one aspect of the present application;

FIGS. 10A-10C are perspective views of exemplary embodiments of a reusable candle system according to one aspect of the present application;

FIGS. 11A-11B are perspective views of exemplary embodiments of a reusable candle system according to one aspect of the present application;

FIGS. 12A-12C are perspective views of exemplary embodiments of a reusable candle system according to one aspect of the present application;

FIGS. 13A-13D are perspective views of exemplary embodiments of a reusable candle system according to one aspect of the present application;

FIG. 14 is a cross-sectional view of an exemplary embodiment of an exterior holder used in the reusable candle system according to one aspect of the present application;

FIG. 15 is a front view of an exemplary embodiment of an exterior holder used in the reusable candle system according to one aspect of the present application;

FIG. 16 is a front view of an exemplary embodiment of a mold used in the reusable candle system according to one aspect of the present application;

FIG. 17A is an exploded perspective view of an exemplary embodiment of a reusable candle system according to one aspect of the present application;

FIG. 17B is a perspective view of the exemplary embodiment of the reusable candle system of FIG. 17A according to one aspect of the present application;

FIG. 17C is a cross-sectional side view of the exemplary embodiment of the reusable candle system of FIG. 17A according to one aspect of the present application;

FIG. 18A is a bottom perspective view of an exemplary embodiment of an insert used in the reusable candle system of FIG. 17A according to one aspect of the present application;

FIG. 18B is a bottom view of the exemplary embodiment of the insert used in the reusable candle system of FIG. 17A according to one aspect of the present application and

FIG. 18C is a cross-sectional side view of the exemplary embodiment of the insert used in the reusable candle system of FIG. 17A according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary candle system allows a user to place perfectly formed replacement candles or melted to perfect form from the candle system's mold methodology into the insert. The insert may then be placed in an exterior holder. The combination of the insert and exterior holder is a barrier technology which minimizes the risk of the flame spreading to combustible surfaces, protects the surface upon which the candle is positioned upon, and protects a user from contact burns. Once the candle is extinguished, the insert may be taken out of the holder and cleaned and reused. The candle system may have one or more molds which allows a user to form replacement candles which perfectly fit and/or melt perfectly into the insert. The mold may be formed of a biodegradable material and may also function as biodegradable packaging

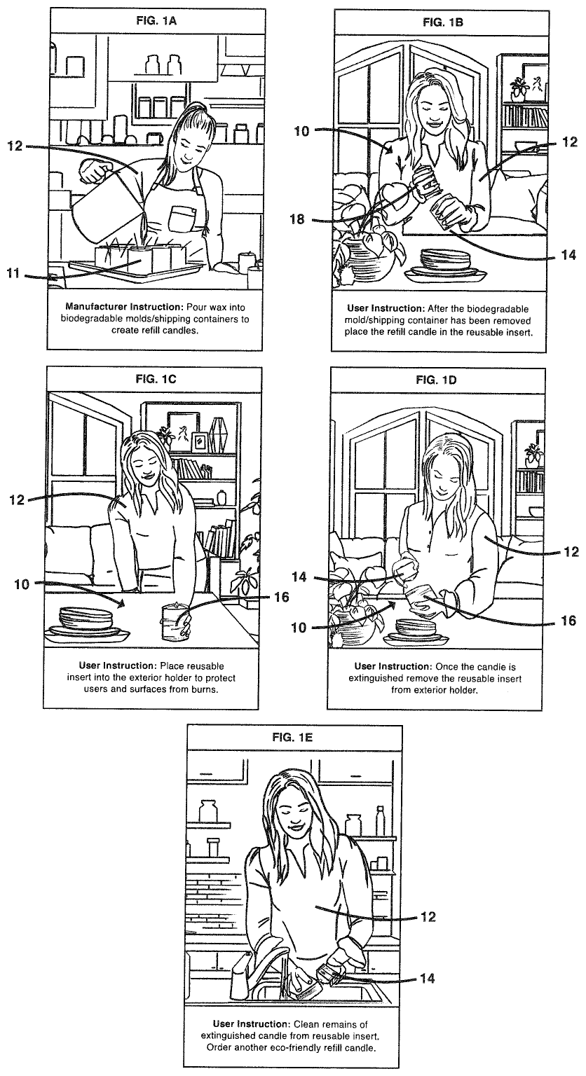

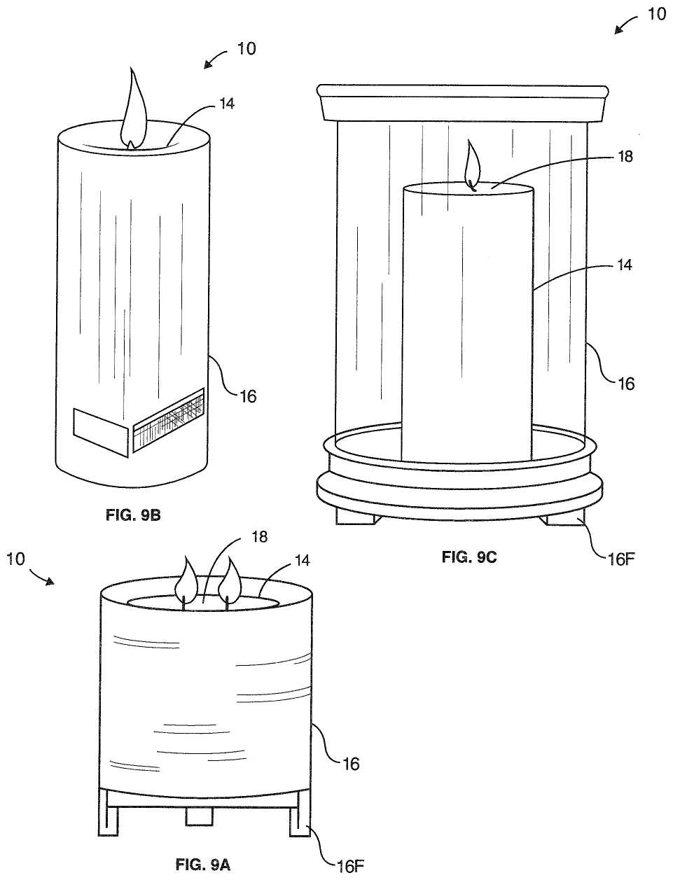

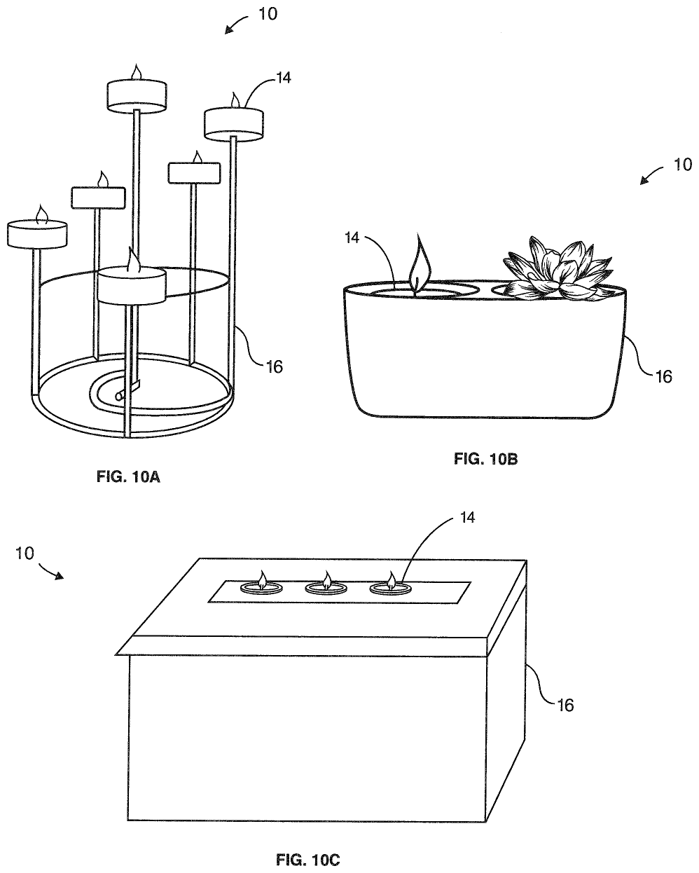

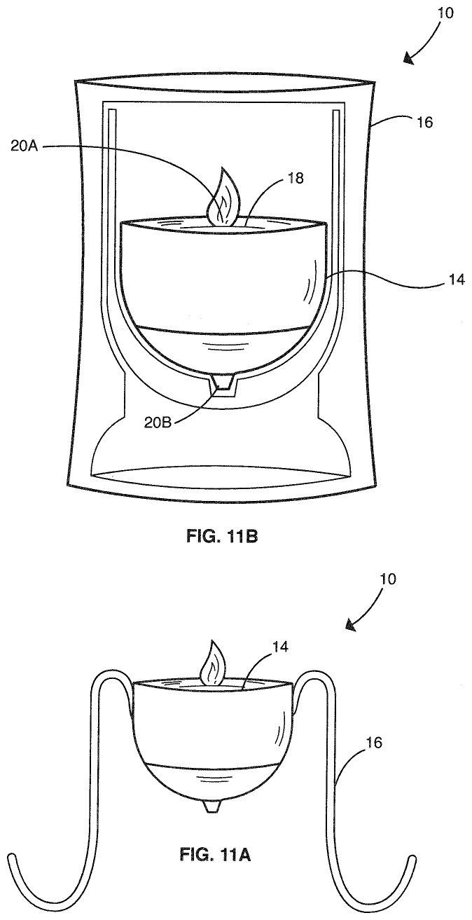

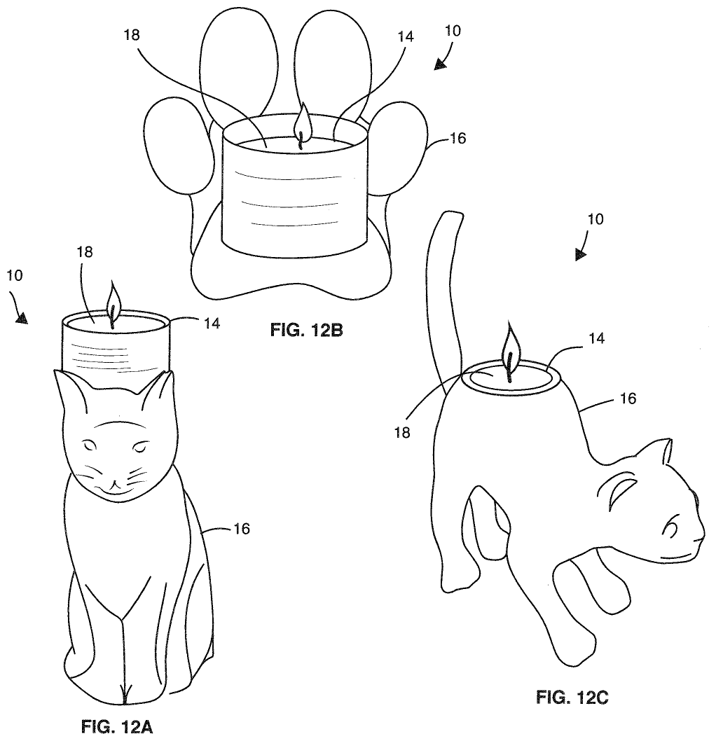

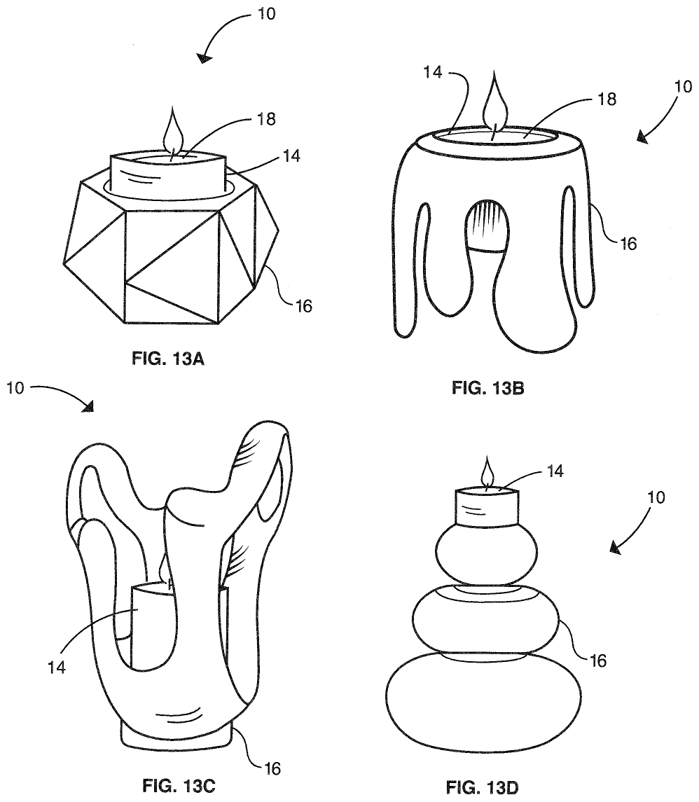

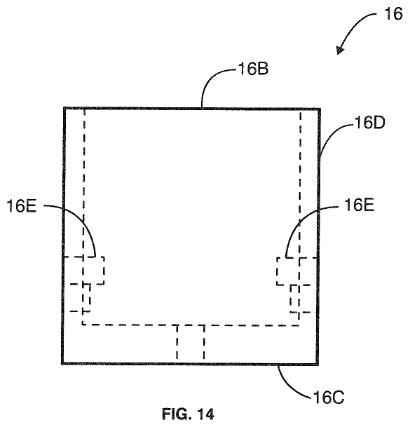

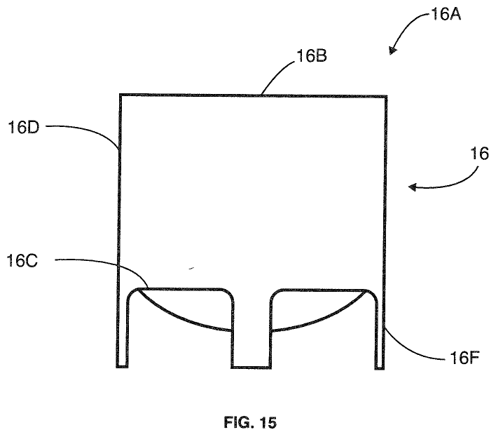

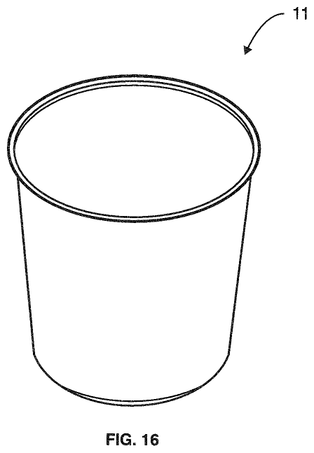

Referring to the FIGS. 1-16, a reusable candle system 10 may be shown and described. The system 10 may allow a user 12 to form new candles 18 from the wax of nearly depleted candles. The system 10 may use a mold 11, an insert 14 and an exterior holder 16. In accordance with one embodiment, the system 10 may have a plurality of molds 11. Each mold 11 may be used for forming the new candle 18 as will be described below. Each mold 11 may come in different shapes and sizes in order to form different types/shapes of candles 18, In accordance with one embodiment, the molds 11 may be reusable. The mold 11 may be used to form candles 18 that fit within the insert 14. A non-flammable, non-heat transferable material that may be easy to clean may be preferred as a material for forming the mold.

Alternatively, the molds 11 may be formed from a heat resistant biodegradable material. For example, Plastarch Material (PSM) may be used, PSM is a biodegradable, thermoplastic resin. It is composed of starch combined with several other biodegradable materials. The starch may be modified in order to obtain heat-resistant properties, making PSM one of few bioplastics capable of withstanding high temperatures. However, different materials may be used as well, such as, but not limited to bagasse, other plant pulps and the like.

It should be noted that the molds 11 may serve other functions. For example, the mold 11 may double as a packaging/shipping container for the candle refills 18. This may ensure that any candle 18 being shipped with the mold 11 is not damaged during transport. Further, since the mold 11 is biodegradable, the mold 11 is eco-friendly. Normally, candles in containers are shipped in their single-use container to protect during shipping and to contain the wax/candle during use. Candles in single-use containers are therefore not generally as eco-friendly as they could be, being mostly made of glass as previously mentioned. In addition to the candle container waste created, many candles in containers are also wrapped in plastic for transport. Most plastics will not decompose in the landfill for hundreds of years (or more) and are thus similarly not eco-friendly.

Each candle 18 may be placed in an insert 14. The insert 14 may prevent tunneling and allow the candle 18 to produce a more even burn to reduce wax waste. Candle tunneling is when only a small portion of the wax around the wick melts and the flame burrows into the candle creating a vertical tunnel within the wax leaving remaining wax around the edges of the container not used during the life of a candle. The insert 14 may be formed of a container 14A having an open top 14B, a floor 14C and side walls 14D formed around the perimeter of the floor 14C. In accordance with one embodiment, the floor 14C may be rounded, flat, wavy and/or concave such that the floor 14C may be curved downwards.

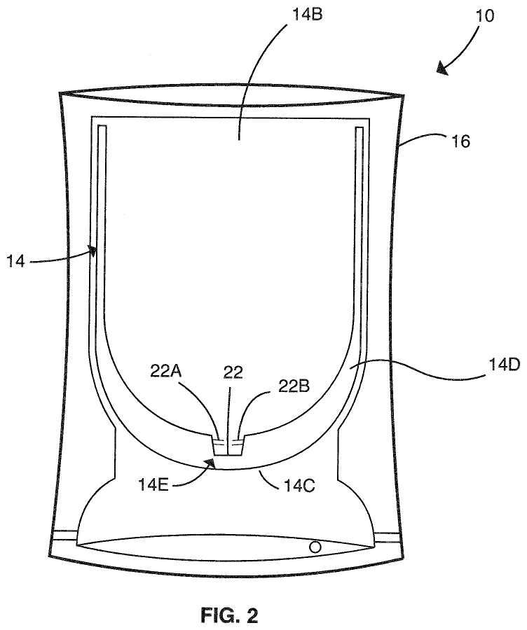

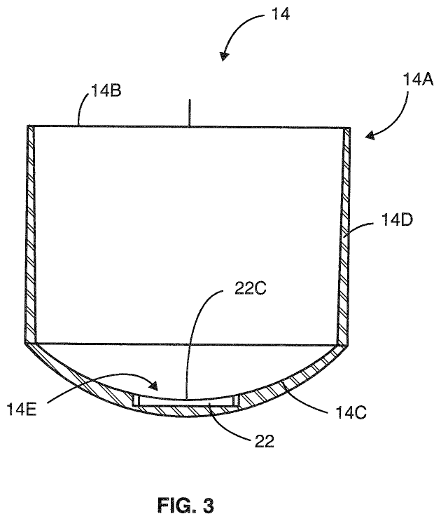

A wick holder 14E may be formed in a center area of the floor 14C. The wick holder 14E may be used to keep and secure the wick 20 in an upright manner within the container 14A. It is important for the safety of the burning candle 18 and performance that the wick 20 is centered in the entire candle 18. When the wick 20 is not centered, the wick 20 may be too close to one side of the container, increasing the chances for intense heat buildup in a specific area. Further, if the wick 20 does not stay upright, the wick 20 may fall on its side and self-extinguish. In accordance with one embodiment, the wick holder 14E may be a channel 22 formed in the center area of the floor 14C as shown in FIGS. 2 and 3. The channel 22 may be sized to ensure that the wick 20 stays in a vertical upright manner.

Alternatively, the channel 22 may be sized to secure and hold a tabbed wick 20A. A tabbed wick 20A is when the candle ignition material such as but not limited to cotton or wood is pre-attached to a tab stand. A tab stand is an independent detached sustainer device for candle ignition material. A tabbed wick 20A is a wick 20 which is positioned in a tab stand 20B or other type of wick holder (hereinafter tab stand). The tab stand 20B is designed to secure and hold the wick 20 in a vertical manner. The channel 22 may be formed in different geometrical shapes depending on the shape of the tab stand 20B to be used. Thus, the channel 22 may be circular, square, rectangular, triangular and the like based on the shape of the tab stand 20B to be used.

The channel 22 may have threading 22A formed in the interior of the channel 22. The threading 22A may allow one to secure the tab stand 20B within the channel 22. The threading 22A may engage the edges of the tab stand 20B to allow a user to rotatably secure the tab stand 20B in the channel 22. If threading 22A is used in the channel 22, the tab stand 20B may have a circular configuration.

Alternatively, the channel 22 may have one or more tabs 22B formed in a top area of the interior of the channel 22. The tab 22B may be used to secure the tab stand 20B in the channel 22 by acting as a resistance to prevent the tab stand 20B from being removed from the channel 22 once the tab stand 20B is pushed past the tab 22B and into the channel 22.

Alternatively, the channel 22 may have a perforated cover 22C formed over a top area of the interior of the channel 22. The perforated cover 22C may be used to secure the tab stand 20B in the channel 22 by acting as a resistance to prevent the tab stand 20B from being removed from the channel 22 once the tab stand 20B is pushed past the perforated cover 22C and into the channel 22.

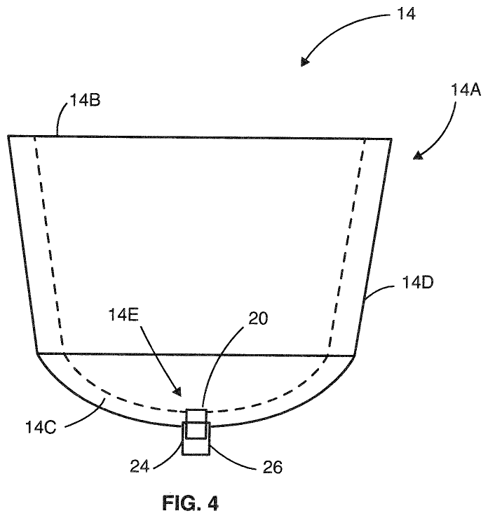

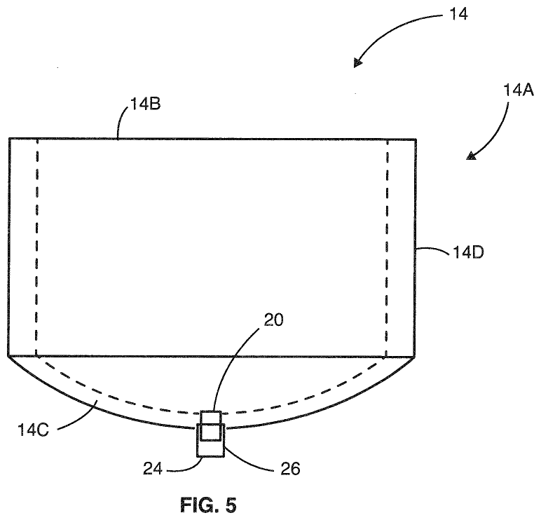

The wick holder 14E may be formed of tubing 26. The tubing 26 may extend through an opening 24 formed in the center area of the floor 14C as shown in FIGS. 4-5. The wick 20 may be inserted directly into the tubing 26. The tubing 26 may be sized to secure and hold the wick 20 in a vertical manner.

Alternatively, the tubing 26 may be sized to secure and hold a tab stand 20B which will secure and hold the wick 20 in a vertical manner. The tubing 26 may be formed in different geometrical shapes depending on the shape of the tab stand 20B to be used. Thus, the tubing 26 may be circular, square, rectangular, triangular and the like based on the shape of the tab stand 20B to be used. In accordance with one embodiment, the tubing 26 may be removable. This may allow for easier cleaning of the insert 14 as well as the tubing 26.

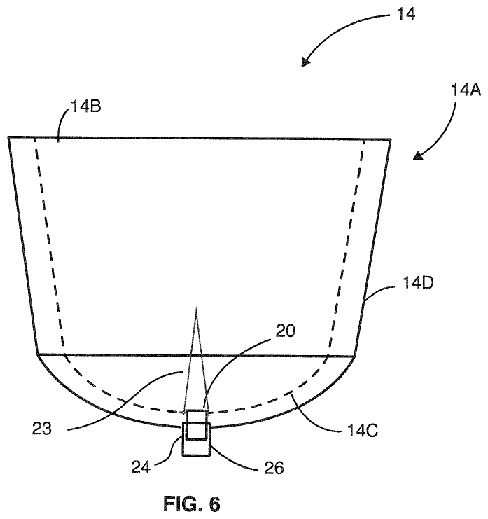

The wick holder 14E may be formed of a spike 23 formed in the center area of the floor 14C as shown in FIG. 6. The spike 23 may be used to secure and hold a wick 20 and/or wick tab which will secure and hold the wick 20 in a vertical manner. While a single spike 23 may be shown, other variations of the spike 23 may be used. For example, a plurality of spikes 23/protrusions may be formed in the center area of the floor 14C. The plurality of spikes 23/protrusions may be laid out in a geometric configuration to form a void area. For example, the plurality of spikes 23/protrusions may be laid out in a circular pattern where a void space is formed in the center of the circular pattern. The void area may be used to hold a wick 20 and/or wick tab which will secure and hold the wick 20 in a vertical manner.

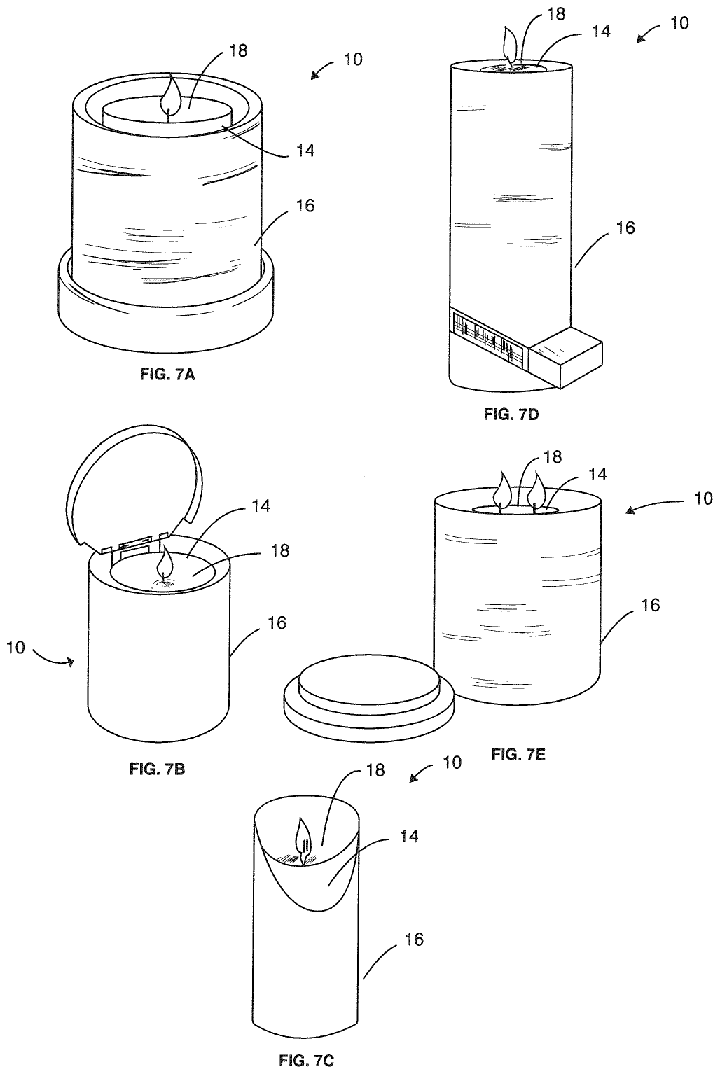

The container 14A may take on different geometrical configurations and sizes. For example, as shown in FIGS. 2, 3 and 5, the container 14A may be cylindrical in nature wherein the side walls 14D of the container 14A may be straight. Alternatively, the container 14A may be conical in nature wherein the side walls 14C of the container 14A may be angled outward from the floor 14C to the open top 14B. The above is given as examples and should not be seen in a limiting manner. The container 14A may take on other geometrical configurations and sizes without departing from the scope of the application. For example, FIGS. 7A-13D show different embodiments of the system 10 wherein the insert 14 may take on different shapes/sizes.

The insert 14 may be formed of different materials. In accordance with one embodiment, the inserts 14 may be reusable. Thus, a non-flammable, non-heat transferable material that may be easy to clean may be preferred. For example, metal, glass, ceramic and/or other similar materials may be used to form the inserts 14.

Alternatively, the inserts 14 may be formed of a heat resistant biodegradable material and non-flammable materials. For example, Plastarch Material (PSM) may be used. PSM is a biodegradable, thermoplastic resin. It is composed of starch combined with several other biodegradable materials. The starch may be modified in order to obtain heat-resistant properties, making PSM one of few bioplastics capable of withstanding high temperatures. However, other materials may be used as well, such as, but not limited to: bagasse, plant pulp and the like.

The system 10 may have an exterior holder 16. In use, the insert 14 may be placed within the exterior holder. When the candle 18 placed in the insert 14 is lit, the exterior holder 16 may be used to protect the surface upon which the system 10 is positioned upon and to protect a user from contact burns when picking up and moving the system 10.

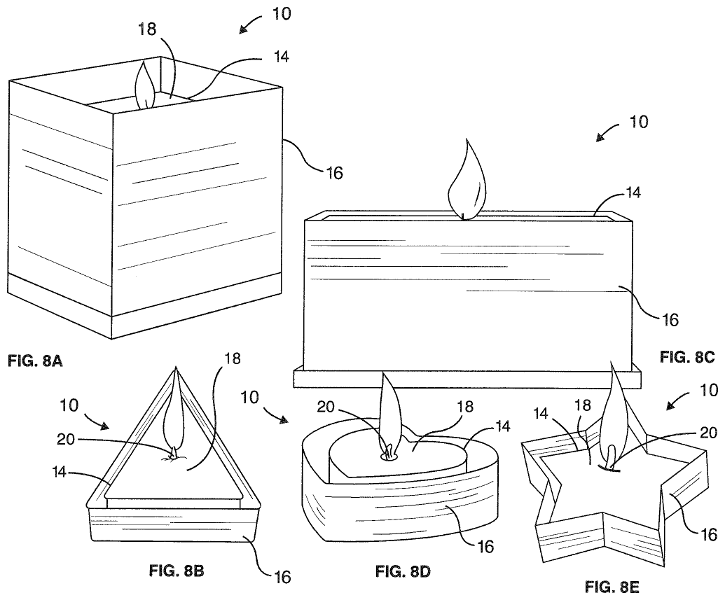

The exterior holder 16 may take on different forms/shapes/sizes. In general, the exterior holder 16 may take on a form similar to that of the insert 14. Thus, if the insert 14 is cylindrical in form, the exterior holder 16 may also be cylindrical in form as may be seen in FIGS. 2, 7A-7E, 9A-9C, 11B, 14 and 15. However, the exterior holder 16 may take on a form similar to that of the insert 14 other than cylindrical as shown in FIGS. 8A-8E, 10A-10C, 11A12A-12C, and 13A-13D.

The exterior holder 16 may be formed of a container 16A having an open top 16B, a floor 16C and side walls 16D formed around the perimeter of the floor 16C. In accordance with one embodiment, a ledge, pillar or other embodiment 16E may be formed around an interior perimeter of the container 16A. The ledge 16E may be used to raise the insert 14 above the floor 16C when the insert is positioned within the exterior holder 16.

The exterior holder 16 may have a plurality of leg members 16F. The leg members 16F may extend down from a bottom area of the exterior holder 16. The leg members 16F may be used to keep the floor 16C of the exterior holder 16 off of the surface upon which it is placed. This may help to protect the surface upon which the candle 18 is positioned upon.

In accordance with one embodiment, the exterior holder 16 and the insert 14 may be formed as a single unit. As a single unit, the insert 14 may or may not be removable depending on the design.

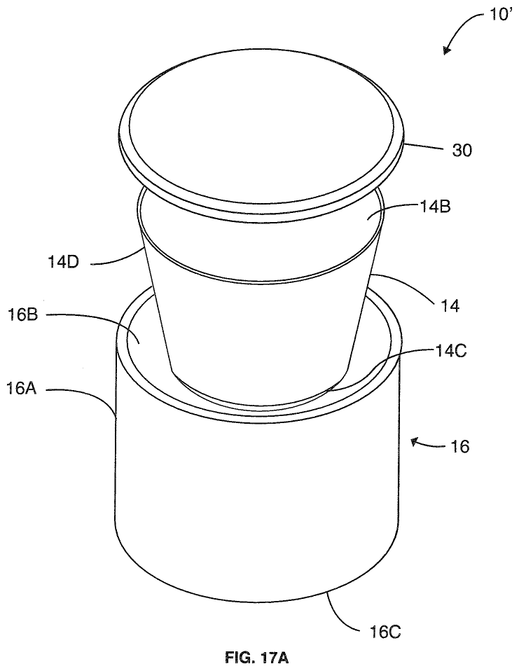

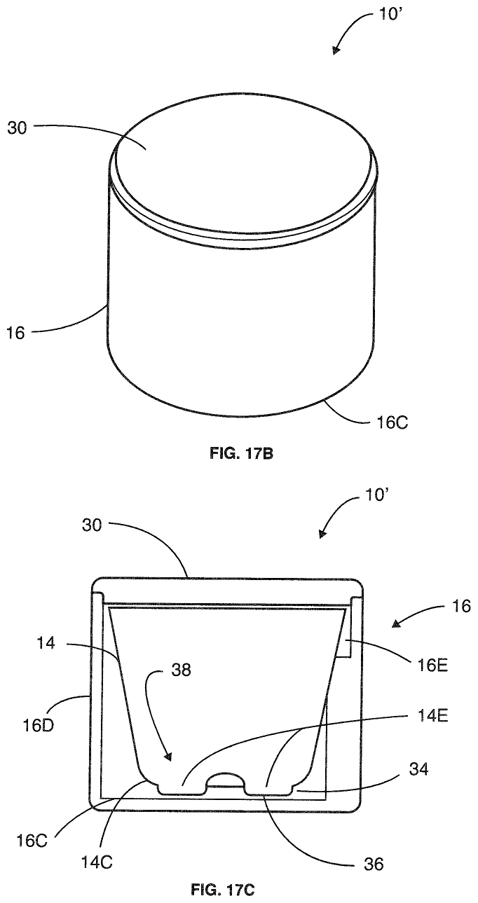

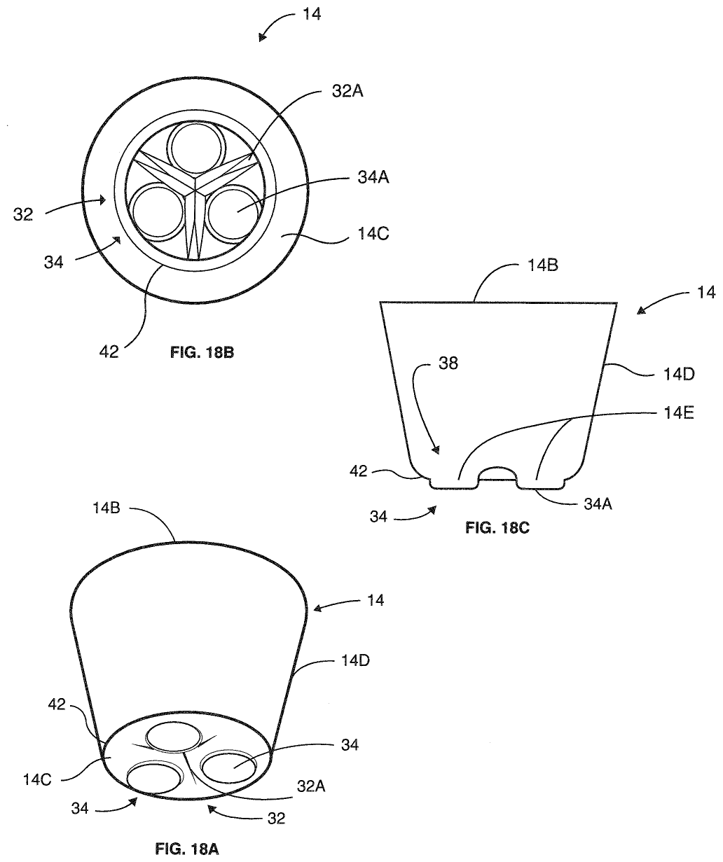

Referring to FIGS. 17A-18C, another embodiment of the system 10′ may be shown. The system 10′ may have an insert 14, an exterior holder 16 and a cover 30. The system 10′ is similar to the system 10 disclosed above. The insert 14 may be formed of a container 14A having an open top 14B, a floor 14C and side walls 14D formed around the perimeter of the floor 14C. In accordance with one embodiment, the floor 14C may be rounded, flat, wavy and/or concave such that the floor 14C may be curved downwards.

A wick holder 14E may be formed in the floor 14C. The wick holder 14E may be used to keep and secure the wick 20 in an upright manner within the container 14A. It is important for the safety of the burning candle 18 and performance that the wick 20 is centered in the entire candle 18. When the wick 20 is not centered, the wick 20 may be too close to one side of the container, increasing the chances for intense heat in a confined area. Further, if the wick 20 does not stay upright, the wick 20 may fall to the side and extinguish.

In accordance with the present embodiment, the insert 14 may have a plurality of wick holders 14E. As may be seen in FIGS. 18A and 18C, the insert 14 may have three wick holders 14E. While the present embodiment shows three wick holders 14E, this is shown as an example. The insert 14 may have any number of wick holders 14E. If multiple wick holders 14E are formed in the insert 14, the wick holders 14E should ensure that the wicks 20 and/or tabbed wick 20A are equidistant from one another, maintaining a safe distance from each other and away from walls of the insert 14.

The wick holder 14E may take on any of the aforementioned embodiments. In the present embodiment, the wick holders 14E may be one or more indentations 38 formed in the floor 14C. Each indentation 38 may be sized to ensure that the wick 20 stays in a vertical upright manner. In the present embodiment, each indentation 38 may be sized to secure and hold a tab stand 20B of a tabbed wick 20A. The indentations 38 may further act as guides to allow a user to insert the pre-made candles 18 within the insert 14 since the indentations 38 may be sized to perfectly fit the tab stand 20B. In accordance with one embodiment, the wick holder 14E may be one or more magnets 36. The magnets 36 may be used to interact with the tab stand 20B of a tabbed wick 20A to keep the tab stand 20B in an upright position.

In accordance with one embodiment, the wick holder 14E may be a combination of magnets 36 and indentations 38. In this embodiment, the magnets 36 may be positioned on the floor 16C of the exterior holder 16. When the insert 14 is placed within the exterior holder 16, the indentations 38 may be aligned so that a corresponding magnet 36 may be positioned below a corresponding indentation 38.

Located on an exterior surface of the floor 14C are a plurality of undulations 32. The undulations 32 may serve a plurality of purposes. The undulations 32 at the bottom of the insert 14 may aid in keeping the wicks 20 and/or tabbed wick 20A more safely apart from each other by providing an additional barrier between the wicks 20 and/or tabbed wick 20A. The undulations 32 may aid in providing maximum wax melt at the bottom of the insert 14 by providing more slanted floor space. The undulations 32 may act as guides to allow the user to more easily insert the pre-molded candle 18 into the insert 14. The user may feel the pre-molded candle hit the undulations 32 of the insert 14 as they place the pre-molded candle 18 in the insert 14 before the pre-molded candle 18 hits the wick holders 14E.

The undulations 32 may also raise the exterior surface of the floor 14C slightly above the floor 16C of the exterior container 16 when the insert 14 is placed within the exterior container 16. Raising the exterior surface of the floor 14C slightly above the floor 16C of the exterior container 16 may allow the heat from the candle 18 to better dissipate as air is allowed to circulate through the system 10.

In accordance with the present embodiment, the undulations 32 may be a plurality of channels 32A. The channels 32A may divide the exterior surface of the floor 14C into a plurality of sections. For example, as shown in FIGS. 18A— 8B, the channels 32 may divide the exterior surface of the floor 14C into three equal pie shape sections. However, this is given as an example and should not be seen in a limiting manner.

The channels 32A may divide the exterior surface of the floor 14C into a plurality of sections wherein the sections may be equal or unequal in size and/or shape.

The undulations 32 may include one or more bulges 34. One or more of the indentations 38 may form a corresponding bulge 34 on an exterior surface 42 of the floor 14C. The bulges 34 may take on any geometric shape/configuration. In the present embodiment, the bugles 34 may be a plurality of circular bulges 34A spaced across the exterior surface of the floor 14C. The bulges 34 provide the same benefits as described above for the undulations 32.

The system 10 may have an exterior holder 16. In use, the insert 14 may be placed within the exterior holder. When the candle 18 placed in the insert 14 is lit, the exterior holder 16 may be used to protect the surface upon which the candle 18 is positioned upon and to protect a user from contact burns when picking up and moving the exterior holder 16.

The exterior holder 16 may take on different forms/shapes/sizes. In general, the exterior holder 16 may take on a form similar to that of the insert 14. The exterior holder 16 may be formed of a container 16A having an open top 16B, a floor 16C and side walls 16D formed around the perimeter of the floor 16C. In accordance with one embodiment, a ledge 16E may be formed around an interior perimeter of the container 16A. The ledge 16E may be used to raise the insert 14 above the floor 16C when the insert is positioned within the exterior holder 16.

The system 10′ may have a cover 30. The cover 30 may be sized and shaped to fit over the open top 16B of the exterior holder 16. The cover 30 may be placed over the exterior holder 16 when the system 10′ is not in use or when a candle is not being burnt within the system 10′.

In operation, a user may easily clean out the reusable insert 14 after use. The insert 14 may then be refilled with a preformed, perfectly matched candle created by the methodology for the reusable insert 14. The reusable insert 14 may then be placed inside the ensemble's exterior holder 16 providing an additional barrier for protection.

The system 10 provides an arrangement wherein molds 11 are provided to form candles 18 which are sized to perfectly fit and/or melt into a perfect fit within the reusable insert 14. The candles 18 may be placed on the reusable candle-holding insert 14, which fits into an exterior holder 16. The insert has a wick stabilizer 14E for securing a free-floating wick or wick tab. The exterior holder 16 houses the insert 14 to protect the user and eliminate surface burn. In accordance with one embodiment, the molds 11 may be biodegradable. The system 10 may also use biodegradable shipping containers to ship one or more components of the system 10 to form a reusable, eco-friendly candle system 10. In accordance with one embodiment, a biodegradable container may be used as the mold and as a shipping container.

The system 10 follows the American Society for Testing and Material guidelines (ASTM). The system 10 provides a unique candle ensemble (i.e., the insert 14 and the exterior holder 16) that uses barrier technology that minimizes the risk of the flame from the candle spreading to combustible components of the candle accessory as a result of foreseeable misuse or failure of the candle. As disclosed above the insert 14 and the exterior holder 16 helps to prevent the flame from the candle spreading to combustible components of the candle accessory. The wick stabilizer 14E may help to prevent flame impingement by keeping the wick upright. This will help to ensure that the flame does not make contact with other surfaces and stays secure.

The foregoing description is illustrative of particular embodiments of the application but is not meant to be a limitation upon the practice thereof. The following claims, including all equivalents thereof, are intended to define the scope of the application.

What is claimed is:

1. A reusable candle system comprising:
an insert housing a candle and having a wick stabilizing device formed at a bottom of the insert for securing a wick of the candle in an upright manner; and
an exterior holder housing the insert.

2. The reusable candle system of claim 1, comprising a mold sized to form replacement candles to fit within the insert.

3. The reusable candle system of claim 1, comprising a mold sized to form replacement candles to fit within the insert, wherein the mold is biodegradable.

4. The reusable candle system of claim 1, comprising a mold sized to faun replacement candles to fit within the insert and to form a shipping container around the candle, wherein the mold is biodegradable.

5. The reusable candle system of claim 1, comprising a top covering an open top of the exterior holder.

6. The reusable candle system of claim 1, comprising a plurality of wick stabilizing devices fainted at the bottom of the insert for securing a plurality of wicks of the candle in an upright manner.

7. The reusable candle system of claim 1, wherein the wick stabilizing device is a channel formed in the bottom of the insert.

8. The reusable candle system of claim 1, wherein the wick stabilizing device is a channel formed in the bottom of the insert, wherein the channel is sized to fit a circumference of a wick of the candle.

9. The reusable candle system of claim 1, wherein the wick stabilizing device is a channel formed in the bottom of the insert, wherein the channel is sized to fit a circumference of a tab stand of a tabbed wick of the candle.

10. The reusable candle system of claim 1, wherein the wick stabilizing device is a threaded channel formed in the bottom of the insert.

11. The reusable candle system of claim 8, comprising at least one tab formed on a top area of the channel.

12. The reusable candle system of claim 1, wherein the wick stabilizing device is at least one protrusion formed on the bottom of the insert.

13. The reusable candle system of claim 1, wherein the wick stabilizing device is at least one magnet.

14. The reusable candle system of claim 6, wherein the plurality of wick stabilizing devices is a plurality of circular indentations formed on the bottom of the insert.

15. The reusable candle system of claim 1, comprising a plurality of undulations formed on the bottom of the insert.

16. A reusable candle system comprising:
an insert housing a candle and having a wick stabilizing device formed at a bottom of the insert for securing a wick of the candle in an upright manner;
a plurality of undulations formed on the bottom of the insert;
an exterior holder housing the insert; and
a top covering an open top of the exterior holder.

17. The reusable candle system of claim 16, comprising a mold sized to form replacement candles to fit within the insert.

18. The reusable candle system of claim 16, comprising a mold sized to form replacement candles to fit within the insert, wherein the mold is biodegradable.

19. The reusable candle system of claim 16, comprising a mold sized to form replacement candles to fit within the insert and to form a shipping container around the candle, wherein the mold is biodegradable.

20. A reusable candle system comprising:
an insert housing a candle;
a plurality of wick stabilizing device formed at a bottom of the insert for securing a plurality of wicks of the candle in an upright manner, wherein the plurality of wick stabilizing devices is a plurality of circular indentations formed on the bottom of the insert;
a plurality of undulations formed on the bottom of the insert;
an exterior holder housing the insert;
a top covering an open top of the exterior holder; and
a mold sized to form replacement candles to fit within the insert and to form a shipping container around the candle, wherein the mold is biodegradable.

21. A reusable candle system comprising:
An insert housing a candle and having a wick stabilizing device formed at a bottom of the insert for securing a wick of the candle in an upright manner; and
a mold sized to form replacement candles to fit within the insert.
